(19) United States
(12) Patent Application Publication
(10) Pub. No.: US 2008/0131762 A1
(43) Pub. Date: Jun. 5, 2008

(54) Photoelectrochemical system for hydrogen production from water

(75) Inventors: Oh-shim Joo, Seoul (KR); Kwang Deog Jung, Seoul (KR); Byoung Koun Min, Gwanju-si (KR); Soo Hang Kim, Bucheon-si (KR); Jun Woo Oh, Seoul (KR)

Correspondence Address: ANDERSON, KILL & OLICK, P.C., 1251 AVENUE OF THE AMERICAS, NEW YORK,, NY, 10020-1182, US

(73) Assignee: KOREA INSTITUTE OF SCIENCE AND TECHNOLOGY, Seoul (KR)

(21) Appl. No.: 11/729,145

(22) Filed: Mar. 28, 2007

(30) Foreign Application Priority Data
Dec. 1, 2006 (KR) 10-2006-0120791

(51) Int. Cl. H01M 6/30

(52) U.S. Cl. 429/111

(57) ABSTRACT

The present invention provides a photoelectrochemical (PEC) system for the production of hydrogen from water, which comprises (A) an electrolytic bath comprising an electrode for catalytic oxidation, an electrode for catalytic reduction, an ion separation film disposed between the two electrodes, and an aqueous electrolyte solution into which the two electrodes and the ion separation film are immersed, and (B) a photoelectrode positioned at the outside of the electrolytic bath and electrically connected to the two electrodes. The inventive PEC system is characterized by disposing a photoelectrode at the position which does not contact aqueous electrolyte solution, thus preventing the lowering of the photoelectrode activities, and maximizing the hydrogen production efficiency.

### FIELD OF THE INVENTION

The present invention relates to a photoelectrochemical system for producing hydrogen from water using photoelectric cells.

### BACKGROUND OF THE INVENTION

There have been many attempts to develop a photoelectrochemical (PEC) system for producing hydrogen directly from water by photoelectrolysis using light (e.g., sunlight) as the energy source due mainly to its environmental friendly nature.

PEC systems that have been studied may include tandem and hybrid cell systems. Specifically, U.S. Pat. No. 6,936,143 (Graetzel et al.) discloses a tandem cell system comprising a laminate of a conductive plate (e.g., F-doped tin dioxide), an optically active oxide layer (e.g., WO₃, Fe₂O₃) and a dye-sensitized layer (e.g., TiO₂), which is brought into contact with an aqueous electrolyte solution to produce hydrogen by photoelectrolysis of water.

Further, U.S. Pat. No. 7,122,873 (Miller et al.) discloses a process for producing hydrogen by water photoelectrolysis using a hybrid solid state PEC cell comprising an optical electrode composed of a semiconducting silicon plate and a semiconducting oxide layer such as WO₃ and Fe₂O₃.

However, the above PEC systems have the disadvantages of the corrosiveness of optical electrodes and the limitation imposed on the selection of electrode material which comes directly in contact with the electrolyte solution. In particular, the silicon photoelectric cell widely used in the art has poor corrosion resistance toward aqueous electrolyte solutions.

### SUMMARY OF THE INVENTION

It is, therefore, an object of the present invention to provide a PEC system which can solve the above-mentioned problems.

In accordance with the present invention, there is provided a PEC system for the production of hydrogen from water, which comprises (A) an electrolytic bath comprising (a) an catalytic oxidation electrode, (b) a catalytic reduction electrode, (c) an ion separation film disposed between the catalytic oxidation and reduction electrodes, and (d) an aqueous electrolyte solution into which the catalytic oxidation and reduction electrodes and the ion separation film are immersed, and (B) a photoelectrode positioned outside the electrolytic bath and electrically connected to the catalytic oxidation and reduction electrodes.

### BRIEF DESCRIPTION OF THE DRAWINGS

The above and other objects and features of the present invention will become apparent from the following description of preferred embodiments given in conjunction with the accompanying drawings, in which:

FIG. 1 is a schematic view of the PEC system for the production of hydrogen from water according to the present invention;

FIG. 2 is a schematic view of the PEC system used in Example according to the present invention;

FIG. 3 is a graph showing the result of hydrogen production amounts using the inventive PEC system and various catalytic oxidation electrodes.

### DETAILED DESCRIPTION OF THE PREFERRED EMBODIMENTS

The inventive PEC system for the production of hydrogen is characterized in that a photoelectrode is disposed at the position which does not contact the aqueous electrolyte, thus preventing the lowering of photoelectrode activities. The photoelectrode is connected to the oxidation and reduction electrodes through separate electrical connecting means.

In accordance with the present invention, the PEC system mainly comprises an electrolytic bath and a photoelectrode positioned at the outside face thereof wherein the electrolytic bath comprises two electrodes each for catalytic oxidation and reduction, and an ion separation film disposed between the two electrodes, the two electrodes and the ion separation film being immersed in an aqueous electrolyte solution, and wherein the photoelectrode is electrically connected to the two electrodes.

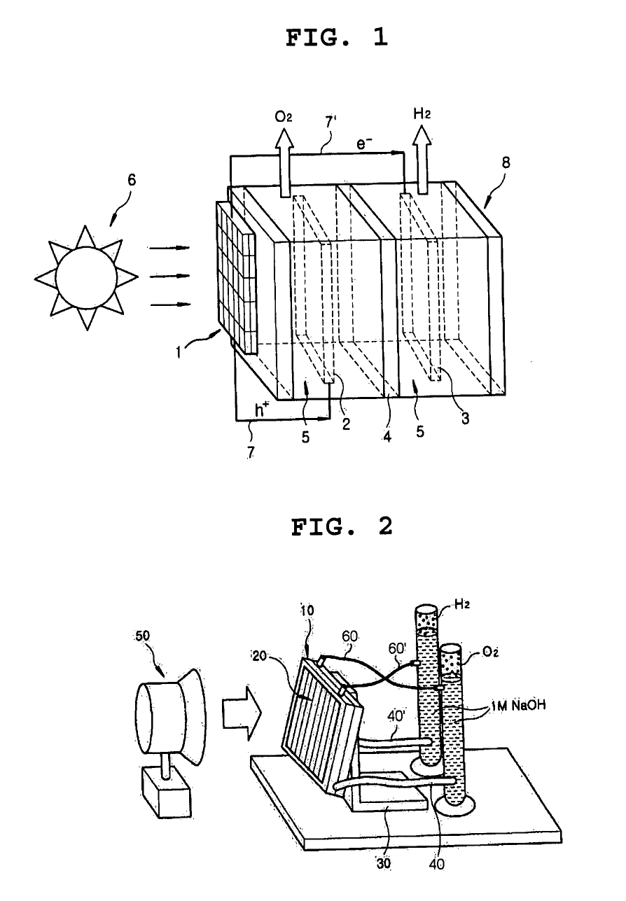

Specifically, in one embodiment of the present invention, as schematically shown in FIG. 1, the inventive PEC system for the production of hydrogen from water comprises photoelectrode (1), catalytic oxidation electrode (2), catalytic reduction electrode (3), ion separation film (4), and aqueous electrolyte solution (5).

Photoelectrode (1) may be a conventional solar cell comprising a conventional semiconducting material capable of producing electron-hole pairs when absorbs light. The photoelectrode may be a photovoltaic type, dye-sensitized type, calcogenide type, oxide type or organic type solar cell, alone or in combination thereof.

Representative examples of the semiconducting material used in the solar cells include silicon compounds such as amorphous, single crystalline (c-Si) or polycrystalline (p-Si) silicon; calcogenide compounds such as cadmium telluride(CdTe), copper indium gallium sellenide(CIGS), and copper indium sellenide(CIS), gallium arsenide(GaAs); polymeric or organic compounds such as polyphenylenevinylene(PPV), Cu-phthalocyanine(CuPc), fullerene(C₆₀), pentacene, poly(3-alkylthiophene)(P3AT), polyfluorene(PFO), and tris(8-hydroxyquinoline)(Alq₃); oxides such as TiO₂, SrTiO₃, FeTiO₃, MnTiO₃, BaTiO₃, ZrO₂, Nb₂O₅, KTaO, WO₃, Fe₂O₃, ZnO₂, SnO₂, PbO, and Bi₂O₃; the above-mentioned oxides doped with a trace amount of a dopant such as Ti, Si, Ge, Pb, Sb, Zr, Bi, Mo, Ta, V, N, and halogen (Cl, F, Br, and I).

In the present invention, photoelectrode (1) may have a size ranging from 1 cm×1 cm to 100 cm×100 cm. The size of the photoelectric cell may be suitably selected so as to maximize the light vs. hydrogen production efficiency. When the voltage produced by the photoelectrode is lower than that required for decomposition of water, an additional photoelectrode may be further employed.

In accordance with the present invention, photoelectrode (1) is disposed at the outside of electrolytic bath (8). For example, photoelectrode (1) may be attached to the outer face of the electrolytic bath by a conventional means, e.g., an electrical wire.

Such an outside position may provide many advantages as compared to the conventional PEC system wherein photoelectrodes are immersed in the aqueous electrolyte solution.

That is, firstly, when the photoelectrodes are positioned in the aqueous electrolyte solution (hereinafter, “in-position” system), the photoelectrodes suffer from corrosion problems, whereas when the photoelectrode is positioned outside of the aqueous electrolyte solution region as in the present invention, such a problem is resolved.

Secondly, the in-position system requires a transparent may be made of conventional materials having high catalytic activities and high stabilities in aqueous solutions, which can reduce over-voltage. Representative examples of the catalytic oxidation electrode material include nickel, iron or nickel oxide, ruthenium oxide(RuO₂), and an alloy thereof, especially Ni, RuO₂, NiFe₂O₄, Fe₂O₃, NiCo₂O₄, CoFe₂O₄, and a combination thereof. Representative examples of the catalytic reduction electrode material include Pt, Pd, Ru, Rh, Ir, CoMo, a CoMo alloy, a combination thereof.

Catalytic oxidation and reduction electrodes (2 and 3) may be in the form of a plate or mesh, which may be supported on a support such as a stainless steel, Ti and Ni.

Ion separation film (4) disposed between catalytic oxidation and reduction electrodes (2 and 3) facilitates selective movement of OH⁻ and H⁺ produced by water electrolysis, thus generating oxygen and hydrogen separately.

Ion separation film (4) may be made of a conventional cationic or anionic exchange resin, which may be suitably selected depending on whether the aqueous electrolyte solution is acidic or basic.

Catalytic oxidation and reduction electrodes (2 and 3) and ion separation film (4) between the two electrodes are immersed into aqueous electrolyte solution (5). Aqueous electrolyte solution (5) may be an aqueous solution of an inorganic strong acid or base, e.g., an aqueous NaOH, KOH, or H₂SO₄ solution having a concentration of 1 to 5 M.

The present invention is further described and illustrated in Examples provided below, which are, however, not intended to limit the scope of the present invention.

### EXAMPLE 1

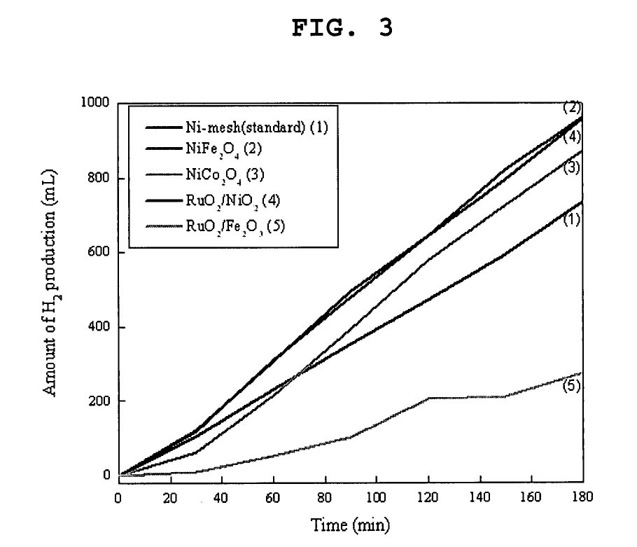

An example of the photoelectrochemical (PEC) system of the present invention shown in FIG. 2 was fabricated as described below:

Specifically, two acryl plates having the size of 12.5×12.5 cm² were prepared. An Ni mesh which serves as an catalytic oxidation electrode, an ion exchange film capable of selectively passing OH ions, and a Pt mesh which serves as a catalytic reduction electrode (3) were placed between the two acryl plates, and the resultant was subjected to vacuum-tightening using screws to obtain a laminate (10).

To the outer surface of the laminate (10), silicon photoelectorde (20) having the size of 12.5×12.5 cm² (V_{oc}=2.59 V, I_{sc}=1.582 amphere, Pₘₐₓ=2.686 W) was attached using an adhesive means, and the resulting assembly was electrically connected to the two electrodes in the laminate (10) using electrical wires.

The silicon photoelectrode (20)/laminate (10) assembly was supported on a base using means (30), and 1 M NaOH aqueous electrolyte solution was introduced into the laminate (10) from vessels containing the NaOH solution via hoses (40 and 40′). The silicon photoelectrode (20) was irradiated using a 100 W halogen lamp (50), to induce a photoelectrochemical reaction by the silicon photoelectrode(20)/laminate(10) assembly. The photoelectrochemical reaction product thus obtained, i.e., oxygen and hydrogen gases, were allowed to emit from the laminate (10) to respective vessels via hoses (60 and 60′), respectively. The amount of water in the vessels reduced by the photoelectrochemical reaction was continuously replenished.

The amount of hydrogen produced by the above photoelectrochemical system was measured on function of the hydrogen gas flow rate (Ritter drum type) at 30 minute intervals. The results are shown in Table 1.

TABLE 1

| | Accumulated | Production |
|---|---|---|
| Lapse | Amount of H₂ | Rate of H₂ |
| Time (hr) | Produced (mL) | (mL/hr) |
| 0 | 0 | 0 |
| 1 | 233 | 233 |
| 2 | 465 | 232 |
| 3 | 735 | 270 |
| 4 | 1005 | 270 |
| 5 | 1255 | 250 |

### EXAMPLE 2

The procedure of Example 1 was repeated except that NiFe₂O₄, NiCo₂O₄, RuO₂/NiO₂, and RuO₂/Fe₂O₃ were used instead of the Ni mesh as the catalytic oxidation electrode.

The catalytic oxidation electrodes were previously prepared by spraying an aqueous solution of nickel nitrate, iron nitrate, cobalt nitrate, or ruthenium chloride on a heated substrate, and heat-treating the resulting spray-coated substrate at 650° C. for 2 hours under an air atmosphere in a furnace.

The amounts of hydrogen produced by the PEC systems obtained using the above electrodes were measured by the same method as in Example 1, and the results are shown in FIG. 3 together with that of Example 1.

As seen from Table 1 and FIG. 3, in accordance with the present invention, hydrogen can be efficiently generated at a high yield by way of using the inventive photoelectrochemical system.

While the invention has been shown and described with respect to the preferred embodiment, it will be understood by those skilled in the art that various changes and modification may be made without departing from the spirit and scope of the invention as defined in the following claims. light receiving part, which transfers light to the electrodes. In contrast, there is no such limitation in the inventive system because the photoelectrode can be directly irradiated by light.

Thirdly, in case of the in-position system, light is transferred to the photoelectrode via the electrolyte solution, and therefore, the light absorption efficiency decreases, thus lengthening the ion transfer distance to lower hydrogen production efficiency. However, the present invention has no such problems.

In addition, in the present invention, the photoelectrode may be easily exchanged.

Furthermore, the inventive PEC system has an advantage that a glass plate is not necessarily involved, thus facilitating the fabrication of a large surface PEC cell and a safe sealing of the aqueous electrolyte solution.

In FIG. 1, photoelectrode (1) is electrically connected to catalytic oxidation electrode (2) and catalytic reduction electrode (3) by electrical wires (7 and 7′). When photoelectrode (1) is irradiated by light, holes(h⁺) and electrons(e⁻) are excited from photoelectrode (1) to immigrate toward oxidation and catalytic reduction electrodes (2 and 3) through electrical wires (7 and 7′), respectively. In catalytic oxidation and reduction electrodes (2 and 3), holes(h⁺) and electrons(e⁻) are reacted with OH⁻ and H⁺ separated from water, respectively, thus producing oxygen and hydrogen, respectively.

Catalytic oxidation and reduction electrodes (2 and 3)

What is claimed is:

1. A photoelectrochemical system for the production of hydrogen from water, which comprises:
(A) an electrolytic bath comprising (a) an catalytic oxidation electrode, (b) a catalytic reduction electrode, (c) an ion separation film disposed between the catalytic oxidation and reduction electrodes, and (d) an aqueous electrolyte solution into which the catalytic oxidation and reduction electrodes and the ion separation film are immersed, and
(B) a photoelectrode positioned outside the electrolytic bath and electrically connected to the catalytic oxidation and reduction electrodes.

2. The photoelectrochemical system of claim 1, wherein the photoelectrode is selected from the group consisting of photovoltaic type-, dye-sensitized type-, calcogenide type-, oxide type-, organic type-solar cells, and a combination thereof.

3. The photoelectrochemical system of claim 1, wherein the photoelectrode has a size ranging from 1 cm×1 cm to 100 cm×100 cm.

4. The photoelectrochemical system of claim 1, wherein the catalytic oxidation electrode is made of a material selected from the group consisting of Ni, RuO₂, NiFe₂O₄, Fe₂O₃, NiCo₂O₄, CoFe₂O₄, and a combination thereof.

5. The photoelectrochemical system of claim 1, wherein the catalytic reduction electrode is made of a material selected from the group consisting of Pt, Pd, Ru, Rh, Ir, CoMo, a CoMo alloy, and a combination thereof.

6. The photoelectrochemical system of claim 1, wherein the ion separation film is made of a cationic or anionic exchange resin.

7. The photoelectrochemical system of claim 1, wherein the aqueous electrolyte solution is a 1 to 5 M aqueous solution of an inorganic acid or base.

8. The photoelectrochemical system of claim 1, wherein the photoelectrode is attached to the outside face of the electrolytic bath by an adhesive means.

9. The photoelectrochemical system of claim 1, wherein the photoelectrode is electrically connected with an electrical wire.
